(19) United States
(12) Patent Application Publication
(10) Pub. No.: US 2003/0144464 A1
(43) Pub. Date: Jul. 31, 2003

(54) Process for the preparation of polyaspartic acid derivatives

(76) Inventors: Nicole Flintrop, Duisburg (DE); Matthias Gay, Essen (DE); Harald Rau, Essen (DE); Ute Schick, Filzengraben (DE); Christian Weitemeyer, Essen (DE)

Correspondence Address: SCULLY SCOTT MURPHY & PRESSER, PC, 400 GARDEN CITY PLAZA, GARDEN CITY, NY, 11530

(21) Appl. No.: 10/349,980

(22) Filed: Jan. 23, 2003

(30) Foreign Application Priority Data
Jan. 23, 2002 (DE) 102 02 316.6

(51) Int. Cl. C08G 63/08

(52) U.S. Cl. 528/354

(57) ABSTRACT

Process for the preparation of polyaspartic acid derivatives of the general formula (I)

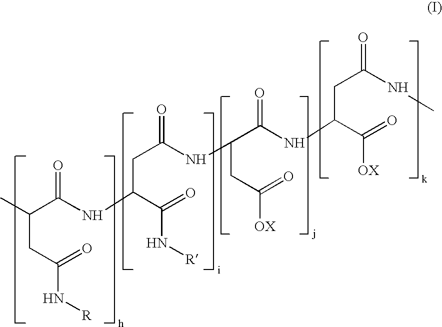

wherein h, i, j, and k represent the molar fraction of each repeating unit and are decimal numbers between ≧0 and <1 where the sum of h, i, j and k is 1 and at least one of the variables h or i has numerical values >0, X independently of each other, is H, alkali metal ions, alkaline earth metal ions or other metal cations, positively charged derivatives of nitrogen, R and R′, independently of one another, are aliphatic, cycloaliphatic, aromatic hydrocarbon radicals or mixtures thereof is provided. The process includes in a first stage, adjusting an aqueous mixture consisting of the basic hydrolysis products of polysuccinimide and amine compounds to pH values of ≦3; andin a second stage, carrying out the aminolysis at temperatures between 140° and 200° C.

### FIELD OF THE INVENTION

The present invention relates to a process for the preparation of polyaspartic acid derivatives, and in particular to a process for the preparation of polyaspartic acid polyetheramides.

### BACKGROUND OF THE INVENTION

Polyamino acid derivatives, in particular polyaspartic acid, have recently received particular attention due to their properties, especially their biodegradability and near-nature character. Applications as biodegradable complexing agents, softeners and detergent builders, inter alia, are proposed for polyamino acid derivatives.

There are a large number of prior art references in which the preparation of polyaspartic acid (PAA) and polysuccinimide (PSI) is described. An overview is given, for example, by M. Schwamborn in Nachr. Chem. Tech. Lab 44 (1996) No. 12. This overview article differentiates between two main preparation methods. Using peptide chemistry methods, it is possible to prepare poly-α- or poly-β-aspartic acids of varying molecular weights in a targeted manner. The processes are very complex and are only used for the synthesis of small amounts on a laboratory scale.

For industrial applications, the thermal polymerization of aspartic acid using catalysts (e.g., phosphoric acid) or maleic anhydride with ammonia is preferred. In this industrial prior art process, the first step always gives polysuccinimide as a reaction product, which is opened using alkaline solutions, preferably sodium hydroxide, to give polyaspartic acid sodium salt. For example, DE-A-42 44 031 describes the reaction of maleic anhydride with ammonia. The prior art process disclosed in DE-A-42 44 031 initially gives polysuccinimide, which is hydrolyzed in solution to give polyaspartic acid sodium salt. In a subsequent spray-drying, solid polyaspartic acid sodium salt can be obtained.

In the prior art, further literature sources are known which describe the preparation of polyaspartic acid sodium salt: see, for example, EP-A-0 578 449, WO-A-214753, EP-A-0 659 875, DE-A-44 20 642, DE-A-36 26 672, EP-A-0 612 784, DE-A-43 00 020, and U.S. Pat. No. 5,219,952.

No industrial prior art process is known which leads directly to free polyaspartic acid.

On the laboratory scale, various approaches are possible. For example, polybenzyl aspartate can be cleaved in solution with hydrogen under heterogeneous catalysis to give free polyaspartic acid. In addition, it is possible to prepare free polyaspartic acid from the sodium salt thereof by means of ion exchange chromatography and subsequently freeze-drying. Both of these prior art processes are industrially very complex and not economically viable.

Thus, for the preparation of polyaspartic acid derivatives on the industrial scale, only polysuccinimide or polyaspartic acid sodium salt in solution are available.

The synthesis of polyaspartic acid derivatives is described widely in the literature.

A standard method is the reaction of polysuccinimide in organic solvents with amines to give polyaspartamides. For example, in U.S. Pat. No. 5,929,198 and DE-A-198 43 455, polysuccinimides from various preparation routes are dissolved in dimethylformamide and reacted with a very wide variety of compounds which contain amine functions, to give amides.

The work-up in this prior art method is expensive since the products generally have to be precipitated out of the reaction solutions, and further purification steps, such as dialysis and freeze-drying, follow. In addition, the solvents used are unacceptable for applications in the field of pharmacy or cosmetics from a toxicological viewpoint since the solvents can never be completely separated off.

A small number of publications deals with the reaction of polysuccinimide in the absence of organic solvents.

DE-A-43 07 114 describes a process in which amino acids are initially introduced in strongly alkaline solution (pH 10 to 11) and reacted with polysuccinimide (=PSI). DE-A-197 20 771 describes the reaction of PSI in aqueous solution with amines with the addition of surfactants and the reaction of PSI with amines without a diluent in a pressurized reactor.

Finally, DE-A-196 31 380 demonstrates a process in which polysuccinimide is reacted, in water, in stages with different types of amines, which differ in regard to the length of the hydrocarbon radicals.

As is clear, use is made exclusively of polysuccinimide in the preparation of polyaspartic acid derivatives. Although the abovementioned publications do indicate that free polyaspartic acid could also be used for syntheses, there are no specific details. This is presumably to be attributed to the relatively high expenditure described above which is required to prepare free polyaspartic acid.

There are, however, no indications in the prior art that polyaspartic acid sodium salt is used for syntheses.

### SUMMARY OF THE INVENTION

An object of the present invention is therefore to provide a process for the preparation of polyaspartic acid derivatives, such as polyaspartic esters and in particular polyaspartamides and/or polyaspartic esteramides, that permits the use of polyaspartic acid sodium salt as a starting material. The present invention also provides a process for the preparation of polyaspartic acid derivatives that may be carried out in an aqueous solution, i.e., without co-use of organic solvents.

The present invention therefore provides a process for the preparation of polyaspartic acid derivatives of the general formula (I)

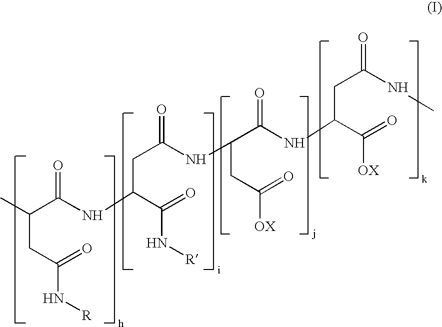

in which

h, i, j, k represent the molar fraction of each repeating unit and are decimal numbers between ≧0 and <1 where the sum of these numbers is 1 and at least one of the variables h, and i is a numerical values >0,

X independently of the others, is H, alkali metal ions or alkaline earth metal ions or other metal cations, positively charged derivatives of nitrogen, such as ammonium salts, salts of amines, hydroxyalkylamines or polyether alkyl(en)amines and salts thereof,

R, R′ independently of one another, may be aliphatic, cycloaliphatic and/or aromatic hydrocarbon radicals which are optionally branched, optionally contain double bonds and optionally contain heteroatoms and/or functional groups,

which comprises

in a first stage, adjusting an aqueous mixture consisting of the basic hydrolysis products of polysuccinimide and amine compounds to pH values of ≦3; and

in a second stage, carrying out the aminolysis at temperatures between 140° and 200° C., preferably at 150° to 180° C.

A particular feature of the present invention is the chemical bonding of the repeating units. The parameters h and j designate an α-linkage, the parameters i and k a β-linkage.

The backbone can have 100% α- or β-linkage, preferably both types are present in any desired ratio relative to one another within the polymer, and the ratio of α- to β-linkage is particularly preferably in the range from 1:10 to 10:1.

### DETAILED DESCRIPTION OF THE INVENTION

In the above formula, R and R′ may be hydrophobic or hydrophilic monomeric, oligomeric or polymeric side chains, in particular linear, branched, saturated and/or unsaturated hydrocarbons, such as, for example, alkyl, alkenyl, aryl substituents and derivatives thereof, preferably linear alkyl groups, particularly preferably in the range from one to twenty carbon atoms, and may be functionalized alkyl groups, such as, for example, carboxyalkyl, sulfoalkyl, thioalkyl, hydroxyalkyl or aminoalkyl, preferably hydroxyalkyl and aminoalkyl. Typical examples thereof include methylamine, dimethylamine, ethylamine, diethylamine, n-propylamine, di-n-propylamine, isopropylamine, diisopropylamine, n-butylamine, di-n-butylamine, tert-butylamine, di-tert-butylamine, hexylamine, dihexylamine, and also octyl-, decyl-, dodecyl-, tetradecyl-, hexadecyl- and octadecylamine, and the dialkylamines thereof, and also benzylamines, phenylamines and derivatives thereof, saturated cyclic hydrocarbon amines, such as, for example, cyclohexylamine and derivatives of these compounds, and also ethanolamine, diethanolamine, aminoethoxyethanol and further linear, branched, saturated and/or unsaturated hydroxyalkylamines in the range from 2 to 20 carbon atoms, which may also contain several hydroxyl groups, preferably a maximum of six hydroxyl groups, and also diamines, such as, for example, 1,3-diaminopropane, 1,4-diaminobutane, 1,6-diaminohexane and also substituted diamines, such as, for example, N,N-dimethylaminopropylamine.

Particularly preferably, R, and R′ are radicals of the following general formula (II)

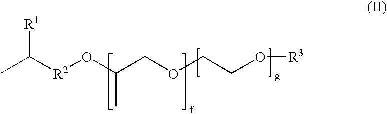

in which

R¹ is hydrogen, a hydrocarbon radical, preferably a linear or branched alkyl radical having 1 to 20, preferably 1 to 4, carbon atoms, such as, for example, a methyl, ethyl, propyl, butyl or aryl radical and substituted derivatives thereof,

R² is a hydrocarbon radical, preferably a linear or branched alkyl radical having 1 to 10, preferably 1 to 4, carbon atoms, or is phenylene groups and substituted derivatives thereof,

R³ is hydrogen, a linear or branched hydrocarbon radical, such as, for example, alkyl or aryl, preferably alkyl in the range C₁ to C₂₀, particularly preferably in the range C₁ to C₄,

f is 0 to 300, preferably 1 to 100, particularly preferably in the range 2 to 10,

g is 0 to 300, preferably 0 to 100, particularly preferably 10 to 20, and

where

the ratio of f to g=0 to 100 to about 60 to 40, and in which the propylene oxide units and ethylene oxide units may be distributed randomly or in blocks.

Adjustment of the pH of the reaction mixture in the first stage is achieved, for example, by adding concentrated organic or inorganic acids. The time point for the acid addition is unimportant and can be varied freely. It is preferably added directly to the aqueous PSI/amine mixture. It is also possible to remove water from the basic solution of the polyaspartimide to such an extent that a stirrable mixture remains which can be admixed with the other reactants.

In a further modification of the process of the present invention, voluminous amines, such as polyether-modified amines, can be initially introduced into the reaction vessel and then reacted with the above starting materials. In this embodiment, it is also possible to react polysuccinimide with polyether-modified amines without a diluent or to only add enough water to form a stirrable reaction mixture.

Polyetheramine is preferably initially introduced into a reaction flask with stirring at a temperature from 100° to 120° C. and admixed with polysuccinimide and reacted at temperatures between 140° and 170° C. No solvent or flow agent is added. Within the scope of these preparation variants, the reaction can be carried out in customary reactors. For the purposes of the present invention, customary reactors are reaction vessels having known impellers, such as anchor stirrers, dissolver disc, mig/intermig and the corresponding stirrer motors.

In a further modification of the preparation process of the present invention, solid polysuccinimide (PSI) is initially introduced into a high-viscosity reactor, preferably from List, and reacted with amines. Typically, PSI is introduced into the reactor at temperatures between 80° and 100° C. and then admixed with the amine component stepwise such that the viscosity of the resulting paste does not exceed the load limit of the high-viscosity reactor. The actual reaction is carried out at a temperature of from120° to 180° C.

The following examples are provided to illustrate the present invention as well to demonstrate some advantages that are obtained therefrom.

### EXAMPLE 1

An approximately 40% strength aqueous solution of polyaspartic acid sodium salt (520 g, 1.5 mol) was adjusted to a pH of about 2 with concentrated sulfuric acid in a three-neck round-bottom flask with stirring. The solution was admixed with methoxypolyoxyalkyleneamine Jeffamine M-1000® from Huntsman (470 g, 0.5 mol), and the pH was checked and adjusted to 2 (total consumption of sulfuric acid: about 110 g). The mixture was heated to 140° C. with stirring, during which water already distilled over. The reaction temperature was increased to 170° C. and the distillation was continued under reduced pressure. In total, distillation was carried out over a period of five hours. This gave a dark brown paste.

### EXAMPLE 2

An approximately 40% strength solution of polyaspartic acid sodium salt (300 g) in water was adjusted to a pH of about 2 with concentrated hydrochloric acid in a flat-flange flask with stirring. The solution was admixed with the methoxypolyoxyalkyleneamine Jeffamine M-1000® from Huntsman (about 640 g), and the pH was checked and adjusted again to 2 (total consumption of hydrochloric acid: about 126 g). This gave a viscous solution which was heated to 140° C. with stirring, during which water already distilled over. The reaction temperature was increased to 170° C. and the distillation was continued under reduced pressure. In total, distillation was carried out for five hours. This gave a dark brown paste.

### EXAMPLE 3

About 300 g (about 1.5 mol) of Jeffamine M-1000® were melted in a flat-flange flask fitted with stirrer and heated to about 100° C. and admixed with 150 g (1.5 mol) of polysuccinimide (average molar mass about 1500 g/mol). The mixture was heated at 130° C. for about five hours and a vacuum was applied during heating, during which no distillate passed over. This gave a high-viscosity brown paste which solidified at room temperature.

### EXAMPLE 4

1600 g of polysuccinimide were initially introduced into a high-viscosity reactor from List and admixed with 400 g of ethanolamine with grinding and heating to 130° C. over the course of 60 min. During this time, about 75 ml of cyclohexanone were metered in to reduce the viscosity. For a further 4 hours, the reaction temperature was increased to 150° C., and during the last 60 minutes, distillation was carried out under reduced pressure. A high-viscosity brown paste was formed which solidified at room temperature.

### EXAMPLE 5

1200 g of polysuccinimide (12.37 mol of imide units; Mn=1500 g/mol) were initially introduced into a high-viscosity reactor from List, grounded for about 20 min., and 500 ml of xylene were added dropwise as water entrainer. At about 100° to 120° C., 530 g (8.7 mol) of ethanolamine and 100 ml of cyclohexanone were added dropwise over the course of 1.5 hours. Over the course of four hours, the temperature was increased to 140° C. and, during this, distillation was carried out under atmospheric pressure and under reduced pressure. The total duration of the reaction was eight hours. At 100° to 120° C., a high-viscosity pale brown paste was drawn off from the List reactor; this solidified immediately at room temperature.

### EXAMPLE 6

An approximately 40% strength aqueous solution of polyaspartic acid sodium salt (422 g, 1.28 mol) was adjusted to a pH of about 2 with concentrated sulfuric acid in a three-neck round-bottomed flask with stirring. The solution was admixed with the methoxypolyoxyalkyleneamine Jeffamine M-1000® from Huntsman (257 g, 0.26 mol) and then with ethanolamine (47 g; 0.77 mol), and the pH was adjusted to 2 (total consumption of sulfuric acid: about 98 g). The mixture was heated to 140° C. with stirring, during which water already distilled off. The reaction temperature was increased to 170° C. and the distillation was continued under reduced pressure. In total, distillation was carried out over a period of 14 hours. This gave a dark-brown paste.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to exact forms and details described and illustrated, but fall within the scope of the appended claims.

What is claimed is:

1. A process for the preparation of polyaspartic acid derivatives of the general formula (I) 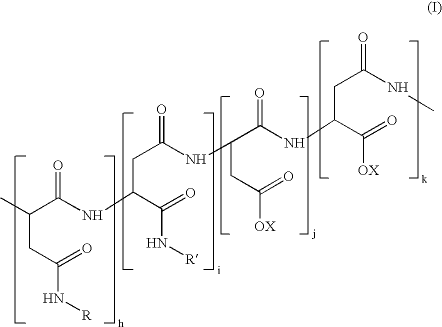
wherein
h, i, j and k represent the molar fraction of each repeating unit and are decimal numbers between ≧0 and <1 where the sum of h, i, j and k is 1 and at least one of the variables h or i has numerical values >0,
X independently of each other, is H, alkali metal ions, alkaline earth metal ions, other metal cations, or a positively charged derivative of nitrogen,
R and R′, independently of one another, are aliphatic, cycloaliphatic, aromatic hydrocarbon radicals or mixtures thereof,
which comprises,
in a first stage, adjusting an aqueous mixture consisting of basic hydrolysis products of polysuccinimide and amine compounds to pH values of ≦3; and
in a second stage, carrying out aminolysis at a temperature between 140° and 200° C.

2. The process for the preparation of polyaspartic acid derivatives of claim 1 wherein R and R′, independently of one another, are linear alkyl groups in the range from 1 to 20 carbon atoms.

3. The process for the preparation of polyaspartic acid derivatives of claim 1 wherein R, and R′, independently of one another, are radicals of the general formula (II) 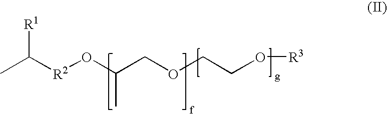
in which
R¹ is hydrogen, a hydrocarbon radical, or aryl radical and substituted derivatives thereof,
R² is a hydrocarbon radical or is phenylene groups and substituted derivatives thereof,
R³ is hydrogen, a linear or branched hydrocarbon radical,
f is 0 to300,
g is 0 to 300, and
where
the ratio of f to g=0 to 100 to about 60 to 40, and in which the propylene oxide units and ethylene oxide units may be distributed randomly or in blocks.

4. The process for the preparation of polyaspartic acid derivatives of claim 1 further comprising an aqueous alkaline solutions of aspartic acid which have a ratio of α-linkage to β-linkage in the range from 1:10 to 10:1.

5. The process for the preparation of polyaspartic acid derivatives of claim 3 wherein R¹ is a linear or branched alkyl radical in the range C₁ to C₄.

6. The process for the preparation of polyaspartic acid derivatives of claim 3 wherein R² is a linear or branched alkyl radical in the range C₁ to C₄ or phenylene group, and R³ is a linear or branched hydrocarbon radical in the range C₁ to C₄.

7. The process for the preparation of polyaspartic acid derivatives of claim 1 wherein X is a positively charged derivative of nitrogen.

8. The process for the preparation of polyaspartic acid derivatives of claim 1 wherein said positively charged derivative of nitrogen is an ammonium salt, a salt of an amine, a hydroxyalkylamine, a polyether alkyl(en)amine or salts thereof.

9. The process for the preparation of polyaspartic acid derivatives of claim 1 wherein R and R′ are branched, contain double bonds, contain heteroatoms, function groups or any combination thereof.

10. The process for the preparation of polyaspartic acid derivatives of claim 3 wherein R¹ is a linear or branched alkyl radical having 1 to 20 carbon atoms.

11. The process for the preparation of polyaspartic acid derivatives of claim 3 wherein R¹ is a linear or branched alkyl radical having 1 to 4 carbon atoms.

12. The process for the preparation of polyaspartic acid derivatives of claim 3 wherein R² is a linear or branched alkyl radical having 1 to 10 carbon atoms.

13. The process for the preparation of polyaspartic acid derivatives of claim 3 wherein R² is a linear or branched alkyl radical having 1 to 4 carbon atoms.

14. The process for the preparation of polyaspartic acid derivatives of claim 3 wherein R³ is an alkyl or aryl.

15. The process for the preparation of polyaspartic acid derivatives of claim 14 wherein said alkyl contains from 1 to 20 carbon atoms.

16. The process for the preparation of polyaspartic acid derivatives of claim 3 wherein f is from 1 to 100.

17. The process for the preparation of polyaspartic acid derivatives of claim 3 wherein f is from 2 to 10.

18. The process for the preparation of polyaspartic acid derivatives of claim 3 wherein g is from 0 to 100.

19. The process for the preparation of polyaspartic acid derivatives of claim 3 wherein g is from 10 to 20.
